(19) United States
(12) Patent Application Publication
(10) Pub. No.: US 2018/0287779 A1
(43) Pub. Date: Oct. 4, 2018

(54) WHITE-BOX CRYPTOGRAPHY METHOD AND APPARATUS FOR PREVENTING SIDE CHANNEL ANALYSIS

(71) Applicant: ELECTRONICS AND TELECOMMUNICATIONS RESEARCH INSTITUTE, Daejeon (KR)

(72) Inventors: Seung Kwang LEE, Daejeon (KR); Yousung KANG, Daejeon (KR); Ju Han KIM, Daejeon (KR); Taesung KIM, Daejeon (KR)

(73) Assignee: ELECTRONICS AND TELECOMMUNICATIONS RESEARCH INSTITUTE, Daejeon (KR)

(21) Appl. No.: 15/940,957

(22) Filed: Mar. 29, 2018

(30) Foreign Application Priority Data
Mar. 29, 2017 (KR) 10-2017-0040284

(51) Int. Cl. H04L 9/00; H04L 9/08

(52) U.S. Cl. CPC H04L 9/003; H04L 9/0869

(57) ABSTRACT

Provided is a white-box cryptography method and apparatus for preventing side channel analysis. An input plain text is encrypted and output according to white-box cryptography and, in this case, the value output according to the encryption includes a first value corresponding to a value obtained by masking an intermediate value obtained by encrypting the plain text with a mask and a second value corresponding to the mask.

### CROSS-REFERENCE TO RELATED APPLICATION

This application claims priority to and the benefit of Korean Patent Application No. 10-2017-0040284 filed in the Korean Intellectual Property Office on Mar. 29, 2017, the entire contents of which are incorporated herein by reference.

### BACKGROUND OF THE INVENTION

### (a) Field of the Invention

The present invention relates to a cryptography method and, more particularly, relates to a white-box cryptography method and apparatus for preventing side channel analysis.

### (b) Description of the Related Art

Attack on an encryption operation apparatus via side channel analysis refers to an analysis method of analyzing information on power consumption or electromagnetic waves generated in an apparatus for performing an encryption algorithm, a memory read/writing record of encryption software, etc. to acquire secret information of an encryption key or the like. Memory read/writing is used as materials for side channel analysis and also affects a power consumption value during an encryption operation and, thus, is also closely related to a power waveform. Hereinafter, for convenience of description, information on power consumption or electromagnetic waves generated in an apparatus for performing an encryption algorithm and a memory read/writing record of encryption software are collectively referred to as “power waveform”.

An attack process on an encryption operation apparatus via side channel analysis is now described in detail. A plurality of power waveforms is collected during an encryption operation and, then, a correlation between a power measurement value at a time point when an operation as an attack target is performed and a predictive bit value or a predictive Hamming weight (HW) value of an intermediate value as an attack target is analyzed to estimate a secret key. Side channel analysis, in more detail, power analysis attack follows a principle in that a correlation coefficient of a power consumption value of an attack point increases when a predictive HW value or a predictive bit value is calculated via an appropriate secret key. To prevent such power analysis attack, a correlation between a power value and an intermediate value estimated as an appropriate secret key by an attacker needs to be reduced or removed.

White-box cryptography (WBC) is a new cryptographic technology for preventing illegal leakage of an encryption key by making encryption key interpretation difficult even if a white-box encryption software operating process is analyzed because an encryption key is hidden in an encryption and decipher algorithm via an encryption technology.

WBC is a code prepared for the case in which an attacker accesses all system resources to read or change a memory value and has various types but basically follows the following principle.

An output value (cryptogram) of a code with respect to all inputs (plain text) is pre-calculated in the form of a table and the table is referred to as a lookup table. In this case, when an output value of a code with respect to all inputs are configured as one lookup table, an entire size is increased and, thus, the entire size of the lookup table is reduced according to a principle of making a plurality of tables in small units for respective code sections and sequentially reading the tables. An attacker of white-box cryptography is assumed to see a value of a memory without change and, thus, linear and non-linear encoding is applied to a lookup table to protect an intermediate value obtained by combining a secret key and a plain text.

White-box cryptography generated according to such a principle applies linear and non-linear encoding to change an intermediate value to a random value and, thus, is expected to be robust to power analysis attack but power analysis attack is possible due to imbalance of linear and non-linear encoding. Accordingly, to respond to power analysis attack on white-box cryptography, there is a need for a method in consideration of imbalance of encoding.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a white-box cryptography method and apparatus having advantages of effectively responding to side channel analysis.

An exemplary embodiment of the present invention provides a cryptography method including inputting a plain text, and encrypting the plain text to obtain a value and outputting the value according to white-box cryptography, wherein the value output according to the encryption includes a first value corresponding to a value obtained by masking an intermediate value obtained by encrypting the plain text with a mask and a second value corresponding to the mask.

The first value may be a value obtained by encoding the masked value and the second value may be obtained by encoding the mask.

The mask may be selected uniformly at random among a plurality of mask values.

The encrypting of the plain text and the outputting of the value may include encrypting the plain text using a secret key to generate an intermediate value, and masking the intermediate value with a mask.

The cryptography method may further include encoding a value obtained by masking the intermediate value and outputting the first value, and encoding the mask and outputting the second value.

The encrypting of the plain text and the outputting of the value may include encrypting the plain text using a secret key to generate an intermediate value, performing first encoding on the intermediate value, masking a value obtained via the first encoding with a mask, and performing second encoding on the value obtained via the masking and outputting the first value.

The cryptography method may further include performing the second encoding on the mask to output the second value.

The first encoding may be linear encoding and the second encoding may be non-linear encoding. The first encoding may be non-linear encoding and the second encoding may be linear encoding.

Probability that each bit of the intermediate value is different from a bit of the masked value may be ½.

Another embodiment of the present invention provides a cryptography apparatus including an input/output unit configured to receive data corresponding to a plain text, and a processor connected to the input/output unit and configured to perform white-box cryptography processing, wherein the processor is configured to encrypt the plain text to obtain a value and to output the value according to white-box cryptography, and wherein the value output according to the encryption includes a first value corresponding to a value obtained by masking an intermediate value obtained by encrypting the plain text with a mask and a second value corresponding to the mask.

The first value may be a value obtained by encoding the masked value and the second value may be obtained by encoding the mask. The mask may be selected uniformly at random among a plurality of mask values.

The processor may be configured to encrypt the plain text using a secret key to generate an intermediate value, to mask the intermediate value with a mask, to encode a value obtained by masking the intermediate value to output the first value, and to encode the mask to output the second value.

The processor may be configured to encrypt the plain text using a secret key to generate an intermediate value, to perform first encoding on the intermediate value, to mask a value obtained via the first encoding with a mask, to perform second encoding on the value obtained via the masking, and to output the first value. In this case, the processor may be further configured to perform the second encoding on the mask to output the second value.

The first encoding may be one of linear encoding or non-linear encoding and the second encoding may be one of non-linear encoding or linear encoding.

### BRIEF DESCRIPTION OF THE DRAWINGS

FIG. 1 is a diagram showing an example of a white-box cryptography process.

FIG. 2 is a diagram showing a white-box cryptography process according to an exemplary embodiment of the present invention.

FIG. 3 is a flowchart of a cryptography method according to an exemplary embodiment of the present invention.

FIG. 4 is a flowchart of a cryptography method according to another exemplary embodiment of the present invention.

FIG. 5 is a diagram showing a structure of a cryptography apparatus according to another exemplary embodiment of the present invention.

### DETAILED DESCRIPTION OF THE EMBODIMENTS

Exemplary embodiments of the present invention are described in detail so as for those of ordinary skill in the art to easily implement with reference to the accompanying drawings. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising”, will be understood to imply the inclusion of stated elements but not the exclusion of any other elements.

The terms such as “first” and “second” are used herein merely to describe a variety of constituent elements, but the constituent elements are not limited by the terms. The terms are used only for the purpose of distinguishing one constituent element from another constituent element. For example, a first element may be termed a second element and a second element may be termed a first element without departing from the teachings of the present invention.

Hereinafter, a white-box cryptography method and apparatus according to an exemplary embodiment of the present invention is described.

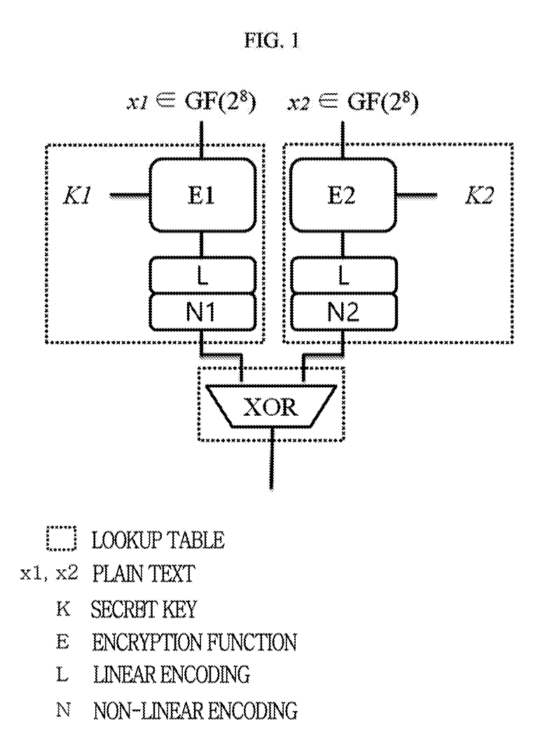

FIG. 1 is a diagram showing an example of a white-box cryptography process.

For example, as shown in FIG. 1, with regard to x, k∈GF(2⁸), x is a plain text and k is a secret key (for convenience of description, description is given in units of 8 bits). Here, G and F denote encoding. With regard to an encryption algorithm or a function E in the encryption algorithm, y1=E(x1, k) and y2=E(x2, k).

An output value of E is encoded as follows based on given linear encoding f and non-linear encoding g.

I1=g1·f(y1)

I2=g2·f(y2) (Equation 1)

I1 is a result obtained by encoding an output value y1 of E and I2 is a result obtained by encoding an output value y2 of E.

Configuration of white-box cryptography in the form of a lookup table may be interpreted as outputting a value I1 when x1 is input to a given table and outputting a value I2 when x2 is input to the given table.

As shown in FIG. 1, when I1 and I2 are combined through an operation such as exclusive OR (XOR, ⊕) subsequent processes, the subsequent processes follow the following principle.

y3=g1⁻¹(I1)⊕g2⁻¹(I2)

I3=g3(y3) (Equation 2)

Here, y3 is a result obtained by performing XOR on a result obtained by decoding I1 via g1⁻¹ and a result obtained by decoding I2 via g2⁻¹ and I3 is a result obtained by encoding y3.

Linear encoding is performed via a product of an invertible matrix and satisfies distributive law with respect to XOR and, thus, it may not be necessary to decode I1 and I2 via f⁻¹ in Equation 2 above. Accordingly, I3 may be considered as a value of g3·f(y1⊕y2). In this case, g1 and g2 may be the same or different.

XOR with respect to I1 and I2 in white-box cryptography may be interpreted as outputting I3 when I1 and I2 are input to an XOR lookup table.

However, due to imbalance of encoding with f and g, when a power analysis attacker performs a side channel analysis (power analysis, statistical analysis, or the like) on a value of I=g·f(y) there is a problem in that the attacker is capable of obtaining a secret key k.

According to an exemplary embodiment of the present invention, to overcome the problem in terms of side channel analysis on white-box cryptography, a value (e.g., a value y in the aforementioned encryption process, which is referred to as an intermediate value), which is obtained by encrypting a plain text using a secure key and is output, is masked with a random value and, then, is encoded. The random value used in masking, i.e., a mask may also be encoded and separately stored. Then, when the mask is unmasked, the encoded mask may be decoded and used.

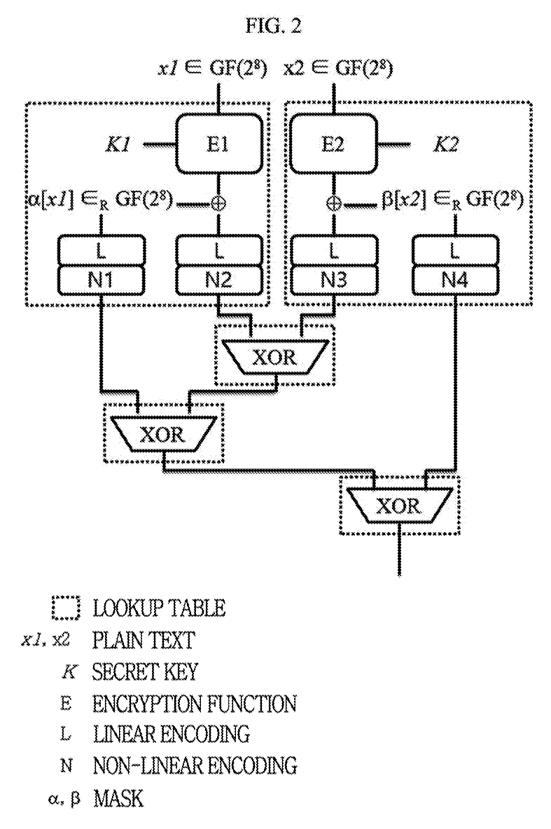

FIG. 2 is a diagram showing a white-box cryptography process according to an exemplary embodiment of the present invention.

Based on the aforementioned example of the cryptography process, as shown in FIG. 2, with regard to x, k∈GF (2⁸), x is a plain text, k is a secret key, and G and F denote encoding. With regard to an encryption algorithm or a function E in the encryption algorithm, y1=E(x1, k) and y2=E(x2, k) are assumed.

According to an exemplary embodiment of the present invention, as exemplified in FIG. 2, values y1 and y2, which are obtained by encrypting plain texts x1 and x2 using a secret key k and are output, may be masked with a random value, i.e., a mask. A length of the mask may be the same as y (y1 and y2). For example, as exemplified above, when y is 8 bits, 8-bit masks m with the same length may be generated and masked with y. In this case, an operation used for masking may be Boolean mask, in more detail, XOR but the present invention is not limited thereto.

y1 and y2 may be masked with a mask m and the masked value may be encoded. The masked value may be encoded as following.

I1=g1·f(y1⊕m1)

I2=g2·f(y2⊕m2) (Equation 3)

Here, I1 is a result obtained by encoding a value obtained by masking y1 with m1 via f and I2 is a result obtained by encoding a value obtained by masking y2 with m2 via f. m1 and m2 are an arbitrary random number.

m1 and m2 may also be encoded as follows.

M1=g3·f(m1)

M2=g3·f(m2) (Equation 4)

In this case, m1 and m2 are merely an arbitrary random number and are not an intermediate value combined with a key and, thus, are not an analysis target.

When the aforementioned processing conditions are configured as a lookup table, for example, a resulting value when an output value with respect to x1 is looked up may be output as both I1 and M1 and a resulting value when an output with respect to x2 is looked up may be output as both I2 and M2.

When a process of combining y1 and y2 through an operation such as exclusive OX (XOR, ⊕) is required, the process may be performed as follows.

y3=g1⁻¹(I1)⊕g2⁻¹(I2)

I3=g4(y3)(→g4·f(y1⊕y2⊕m1⊕m2))

I4=g5{g4⁻¹(I3)⊕g3⁻¹(M1)}(→g5·f(y1⊕y2⊕m2))

I5=g6{g5⁻¹(I4)⊕g3⁻¹(M2)}(→g6·f(y1⊕y2)) (Equation 5)

Here, y3 is a result obtained by performing XOR on a result obtained by decoding I1 via g1⁻¹ and a result obtained by decoding I2 via g2⁻¹ and I3 is a result obtained by encoding y3. I4 is a result obtained by performing XOR on a result obtained by decoding I3 via g4⁻¹ and a result obtained by decoding M1 via g3⁻¹ and I5 is a result obtained by performing XOR on a result obtained by decoding I4 via g5⁻¹ and a result obtained by decoding M2 via g3⁻¹.

In this case, g1 to g6 may be different or the same. In addition, an order of unmasking m1 and m2 may also be changed. Lastly, a value of y1⊕y2 may be obtained via f⁻¹·g6⁻¹(I5).

A white-box cryptography lookup table with the above principle applied thereto may be generated.

According to an exemplary embodiment of the present invention, a mask used in making may satisfy the following condition.

To more stably response to side channel analysis, when a value, for example, y=E(x, k) is 8 bits that belong to GF (2⁸), a mask m that is generated with well-balanced distribution may flip each bit of y with well-balanced distribution. That is, with regard to an arbitrary m∈GF (2⁸) generated with well-balanced distribution, y′=E(x, k)⊕m and, when yᵢ is an i^{th} bit of y, the following probability may be satisfied.

Pr[yᵢ≠y′ᵢ]=½(where 1≤i≤8)

Pr[yᵢ≠y′ᵢ]=½( [symbol] ,1≤i≤8) (Equation 6)

When each bit of an intermediate value (y) is changed according to of probability (Pr), probability that each bit of y′ is changed for each y may be ½ irrespective of an output value of encryption E depending on a plain text x and a secret key k. That is, the probability that each bit of an output value y obtained by encrypting a plain text x using a secret key k and a corresponding bit of y′ obtained by masking y using a mask m are different may be ½. Accordingly, attack that is independently distributed from a secret key k to analyze an intermediate value may be defended.

Accordingly, when a lookup table obtained by encoding a value of y′=E(x, k)⊕m is generated with respect to all x∈GF (2⁸), x∈GF (2⁸) and, thus, a mask for making an output value of E that is a value of 0 to 255 may be generated with well-balanced distribution. According to an exemplary embodiment of the present invention, a mask may be selected uniformly at random. That is, the mask is selected at random with well-balanced distribution and, thus, distribution of values of the selected mask needs to be well-balanced.

In addition, each bit of y′ may also be changed to well-balanced distribution and, thus, a condition of Pr[yᵢ≠y′ᵢ]=½ may be satisfied.

With respect to all x∈GF (2⁸), a mask that satisfies a specific condition may be generated. For example, a limit may be set to generate an arbitrary mask m with a Hamming weight (HW) of 4. Differently from the above case in which a HW of a mask m is set to a specific number, a value of HW(y⊕m), i.e., HW of the masked value may be implemented as a specific value.

According to an exemplary embodiment of the present invention, one or more masks may also be used with respect to one intermediate value. In addition, the same mask may be applied to different intermediate values.

A position in which masking is performed may be prior to encoding of an intermediate value. When encoding includes linear encoding and non-linear encoding, the position may be positioned between linear encoding and non-linear encoding. When an order of linear encoding and non-linear encoding is changed, the position in which masking is performed may be between non-linear encoding and linear encoding. Only one of linear encoding and non-linear encoding may be used in some cases or a plural number of linear encoding and non-linear encoding may be used in some cases.

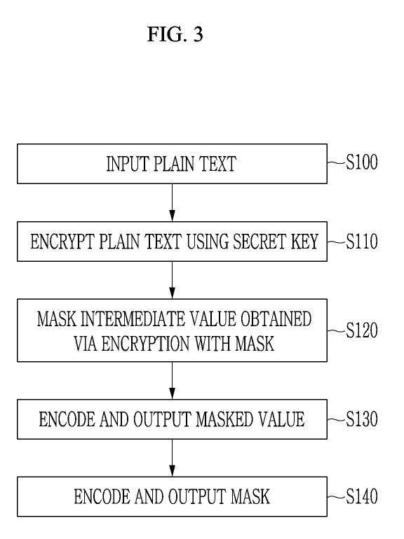

FIG. 3 is a flowchart of a cryptography method according to an exemplary embodiment of the present invention.

When a plain text is input, a first value corresponding to a value obtained by masking an intermediate value, obtained by encrypting a plain text using a secret key, with a mask and a second value corresponding to the mask may be output based on white-box cryptography according to an exemplary embodiment of the present invention

In detail, as shown in FIG. 3, when a plain text is input, encryption may be performed using a secret key (S100 and S110).

The plain text may be encrypted using the secret key to obtain an intermediate value and the intermediate value may be masked with a mask (S120). Here, the mask may be selected uniformly at random among candidate masks generated with well-balanced distribution.

A value obtained by masking a masked value, i.e., an intermediate value with a mask may be encoded and output (S130) and the mask used in making may be encoded and output (S140). Here, a value output via operation S130 may be the first value and a value output via operation S140 may be the second value. Here, operations S130 and S140 may be simultaneously performed.

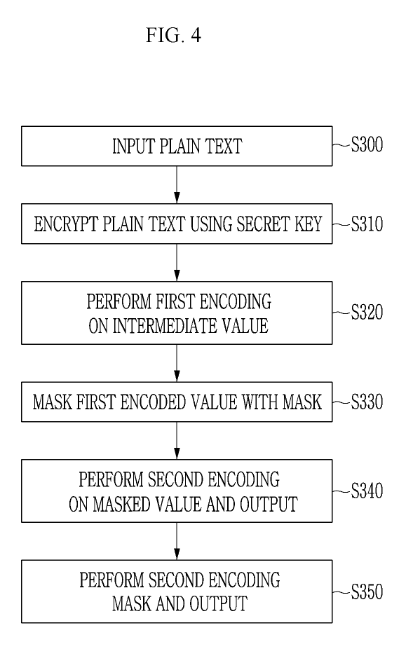

FIG. 4 is a flowchart of a cryptography method according to another exemplary embodiment of the present invention.

Here, encoding may include first encoding and second encoding. The first encoding may be linear encoding, the second encoding may be non-linear encoding, or the first encoding may be non-linear encoding and the second encoding may be linear encoding.

As shown in FIG. 4, when a plain text is input, encryption may be performed using a secret key (S300 and S310).

The plain text may be encrypted using the secret key to obtain an intermediate value and first encoding may be performed on the intermediate value (S320).

The first encoded value may be masked with a mask (S330). Here, the mask may be selected uniformly at random among candidate masks generated with well-balanced distribution.

The second encoding may be performed on the masked value to output a lastly encoded value (S340). The second encoding may be performed on the mask used in masking to output the encoded value (S350). Here, the value output via operation S340 is the first value and the value output via operation S350 may be the second value. Here, operations S340 and S350 simultaneously performed.

An exemplary embodiment of the present invention may respond to attack via side channel analysis on an apparatus for performing a white-box cryptography algorithm. Particularly, an exemplary embodiment of the present invention may respond to side channel analysis due to imbalance of encoding used to generate a white-box cryptography lookup table, thereby effectively protecting a secret key.

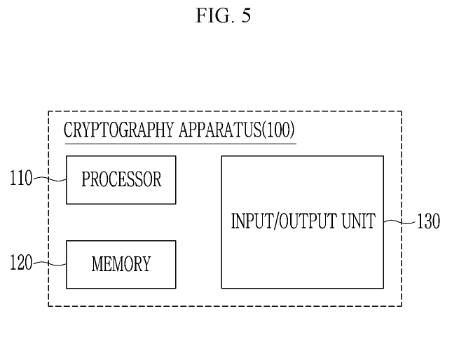

FIG. 5 is a diagram showing a structure of a cryptography apparatus according to an exemplary embodiment of the present invention.

As shown in FIG. 5, a cryptography apparatus 100 according to an exemplary embodiment of the present invention may include a processor 110, a memory 120, and an input/output unit 130. The processor 110 may be configured to implement the methods described with reference to FIGS. 2 to 4.

The memory 120 may be connected to the processor 110 and may store various pieces of information related to an operation of the processor 110. The memory 120 may store instructions for an operation performed by the processor 110 or load and temporally store instructions from a storage (not shown).

The processor 110 may execute the instructions stored or loaded in the memory 120. The processor 110 and the memory 120 may be connected to each other through a bus (not shown) and the bus may also be connected to an input/output interface (not shown).

The input/output unit 130 may be configured to output a processing result of the processor 110 or to receive data corresponding to a plain text and to provide the data to the processor 110.

Exemplary embodiments of the present invention may be implemented through a program for performing a function corresponding to a configuration according to an exemplary embodiment of the present invention and a recording medium with the program recorded therein as well as through the aforementioned apparatus and/or method and may be easily implemented by one of ordinary skill in the art to which the present invention pertains from the above description of the exemplary embodiments.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A cryptography method comprising:
inputting a plain text; and
encrypting the plain text to obtain a value and outputting the value according to white-box cryptography,
wherein the value output according to the encryption includes a first value corresponding to a value obtained by masking an intermediate value obtained by encrypting the plain text with a mask and a second value corresponding to the mask.

2. The cryptography method of claim 1, wherein:
the first value is a value obtained by encoding the masked value and the second value is obtained by encoding the mask.

3. The cryptography method of claim 1, wherein:
the mask is selected uniformly at random among a plurality of mask values.

4. The cryptography method of claim 1, wherein:
the encrypting of the plain text and the outputting of the value includes
encrypting the plain text using a secret key to generate an intermediate value; and
masking the intermediate value with a mask.

5. The cryptography method of claim 4, further comprising:
encoding a value obtained by masking the intermediate value and outputting the first value; and
encoding the mask and outputting the second value.

6. The cryptography method of claim 1, wherein:
the encrypting of the plain text and the outputting of the value includes
encrypting the plain text using a secret key to generate an intermediate value;
performing first encoding on the intermediate value;
masking a value obtained via the first encoding with a mask; and
performing second encoding on the value obtained via the masking and outputting the first value.

7. The cryptography method of claim 6, further comprising
performing the second encoding on the mask to output the second value.

8. The cryptography method of claim 6, wherein:
the first encoding is linear encoding and the second encoding is non-linear encoding.

9. The cryptography method of claim 6, wherein:
the first encoding is non-linear encoding and the second encoding is linear encoding.

10. The cryptography method of claim 1, wherein:
probability that each bit of the intermediate value is different from a bit of the masked value is ½.

11. A cryptography apparatus comprising:
an input/output unit configured to receive data corresponding to a plain text; and
a processor connected to the input/output unit and configured to perform white-box cryptography processing,
wherein the processor is configured to encrypt the plain text to obtain a value and to output the value according to white-box cryptography; and
wherein the value output according to the encryption includes a first value corresponding to a value obtained by masking an intermediate value obtained by encrypting the plain text with a mask and a second value corresponding to the mask.

12. The cryptography apparatus of claim 11, wherein:
the first value is a value obtained by encoding the masked value and the second value is obtained by encoding the mask.

13. The cryptography apparatus of claim 11, wherein:
the mask is selected uniformly at random among a plurality of mask values.

14. The cryptography apparatus of claim 11, wherein:
the processor is configured
to encrypt the plain text using a secret key to generate an intermediate value, to mask the intermediate value with a mask, to encode a value obtained by masking the intermediate value to output the first value, and to encode the mask to output the second value.

15. The cryptography apparatus of claim 11, wherein:
the processor is configured
to encrypt the plain text using a secret key to generate an intermediate value, to perform first encoding on the intermediate value, to mask a value obtained via the first encoding with a mask, to perform second encoding on the value obtained via the masking, and to output the first value.

16. The cryptography apparatus of claim 15, wherein
the processor is further configured to
perform the second encoding on the mask to output the second value.

17. The cryptography apparatus of claim 15, wherein:
the first encoding is one of linear encoding or non-linear encoding and the second encoding is one of non-linear encoding or linear encoding.
